(19) United States
(12) Patent Application Publication
(10) Pub. No.: US 2007/0144033 A1
(43) Pub. Date: Jun. 28, 2007

(54) System and method for operating a drying unit

(76) Inventors: Tomasz P. Kocjan, Buffalo Grove, IL (US); Mariusz Switalski, Des Plaines, IL (US)

Correspondence Address: SCHWARTZ COOPER CHARTERED;IP DEPARTMENT, 180 NORTH LASALLE STREET, SUITE 2700, CHICAGO, IL, 60601, US

(21) Appl. No.: 11/637,598

(22) Filed: Dec. 12, 2006

Related U.S. Application Data
(63) Continuation-in-part of application No. 10/603,018, filed on Jun. 24, 2003.

(51) Int. Cl. F26B 3/00; F26B 21/00

(52) U.S. Cl. 34/476; 34/497; 34/524

(57) ABSTRACT

A system and method for operating a drying unit are provided. A temperature selector provides for the selection of a temperature setting, and a thermometer senses a temperature within the drying unit. A controller generates a power intensity setting, wherein the power intensity setting is based on a fractional value of the temperature setting. A comparator compares the power intensity setting to a base power setting, and a heating element receives a signal to energize based on the comparison of the power intensity setting to the base power setting.

### CROSS-REFERENCE TO RELATED APPLICATIONS

This application is a continuation-in-part of U.S. patent application Ser. No. 10/603,018, filed Jun. 24, 2003, currently pending, to which priority is claimed, and which is incorporated herein by reference.

### TECHNICAL FIELD

The invention relates generally to printing equipment. More specifically, the present invention provides a system and method for improving control of the operating parameters of a drying unit or dryer used in setting or curing a printed material on textiles and graphics.

### BACKGROUND OF THE INVENTION

Printed indicia for applying to items of clothing, such as T-shirts, sweatshirts, golf shirts, shorts, hats, and the like, as well as other cloth and paper goods, such as banners, posters, bags, flags, and the like, have become very popular over the last 30 years. Boutiques specializing in printing fanciful and textual indicia such as slogans, college names, sports team names and logos, licensed characters, and the like, on these various media, are commonly seen in stores across the country. The indicia available at these stores can be pre-printed on a substrate and applied with a heated press by operators at such boutiques to any of the aforementioned items purchased by a consumer, or they can be screen printed directly onto the items for later purchase.

In the screen printing process, a stencil screen is typically blocked (called “masked” in the industry) to embody the desired indicia and then placed over the item to be printed. A material, e.g., ink, of one color is then added to the screen surface and flooded onto the indicia by a flood bar of conventional design. The ink may be of any type well-known in the industry for screen printing. After the ink is flooded onto the screen, the ink is squeegeed through the screen interstices onto the item, leaving ink of the desired color where the interstices in the screen are unblocked. The squeegee can be of any type known in the art. Each color is applied separately through screen printing. At times during the printing process the article is also cured or dried through conventional and well known means to set the ink and prevent smearing, etc. After printing is completed on the item, the item printed upon is typically moved to a dryer or the like to permanently set the ink onto the substrate or textile.

Assignee of the present invention, M&R Printing Equipment, Inc., Glen Ellyn, Ill., makes several successful textile and graphics printing presses, such as the PROCESSOR®, the RENEGADE™, the PATRIOT®, the ECLIPSE™, the SATURN™, the ADVANTAGE™, the CONQUEST™, the CHALLENGER®, the GAUNTLET®, the SPORTSMAN™, the TERMINATOR™, the ULTIMATE®, the PREDATOR®, the CHAMELEON®, the PREMIERE™, the TRANSFER PRESS™, the BELTPRINTER™, and the PERFORMER™, screen printing systems.

As to particulars, a screen printing machine has at least one station for each color employed. For example, a design incorporating two colors will have at least two printing stations, one for each color. A design employing eight colors will have at least eight stations. Each station generally includes a printing head, which supports a single screen, the specific ink to be used at that station, and a mechanism for applying the ink to the textile. Only one color is employed at each station. The machine will frequently employ one or more setting devices, e.g., flash curing unit, heater, dryer, etc., to cure or set the ink. Specifically, a curing unit is frequently disposed between each printing head so that the textile being printed upon is cured immediately upon printing and before the next color is printed on the first color. For this reason, curing units are made to replace printing heads at the stations. Thus, a machine having 8 stations may have 4 printing head stations and 4 curing stations, with each curing station being disposed between printing stations.

Generally, the substrate to be printed upon travels from station (printing or curing) to station (printing or curing) by one of a number of methods, such as a chain (oval machine) or a rigid arm (carousel/turret machine). In some less expensive models, printing heads are brought to the textile being printed upon.

There are generally three types of machines, that being in-line, rotary—often called a carousel or turret—and oval. In a carousel machine, the stations (with either a printing head or a flash curing unit) are supported on spoking spider arms. The textiles to be printed upon are supported on pallets. These pallets are supported by a separate set of spoking spider arms usually situated below the spider arms supporting the printing heads or curing units. The spider arms carrying the pallets rotate and stop under each station. After stopping, the pallets are brought proximate the printing head or curing unit and printed upon or flash cured. Thereafter, the spider arms supporting the pallets are rotated to the next station.

In an in-line or oval machine, a chain drives the pallet supporting the textile or graphics from station to station. At each station, a printing head or curing unit engages the textile or graphics and prints or cures the material upon the textile or graphics.

In each of the above machines, space or areas are provided (between the spider arms of the turret machine or along a part of the oval track of the oval machine) to load and unload the textiles or graphics onto or from the pallets.

Numerous inks are available in the industry from many different producers. Such inks include water base, sublimation, and plastisol. The ink is cured or gelled on the textile, graphic, or substrate to a critical temperature. The temperature during the curing process must be kept within a window suitable for the ink-setting conditions, typically between 125° F. to 450° F. Unfortunately, with some inks and/or textiles, temperatures are crucial. The quality, color and lifetime of a product may be negatively affected by incorrect temperatures and curing or flash times. For example, with plastisols, the temperature must reach 320° F. However, in a range (below 320° F. or above 350° F.), the plastisol will not properly set, resulting in cracking, or it may become liquefied. For example, if the temperature is too low, the plastisol will not cure properly, and will not adhere to the textile/substrate; if the temperature exceeds 350° F., the plastisol will over-gel. Similarly, if a dye in the textile is overheated, it will migrate. Dye sublimation occurs if a textile printed upon is over heated, or “over flashed,” resulting in the dyes of the textile sublimating into the ink. Finally, the textile or substrate being printed upon may scorch or burn, thereby ruining the product and increasing waste and production costs.

In addition to the above, the color set onto the textile will be greatly affected by both the temperatures and the flash or curing time. Clearly, the curing process and machinery are integral to ensure the quality of printed pattern. As such, there are various operating parameters that must be monitored and controlled.

Today's printing processes utilize multiple devices and sensors to facilitate the printing and screening steps and to ensure high quality results. Detailed planning is required to coordinate and integrate the various devices into a reliable manufacturing process.

Several important steps, e.g., sub-processes, in the overall printing process are, or should be, monitored to ensure high quality printing on textiles and graphics. One such integral sub-process involves the aforementioned setting of the deposited ink. It is important to closely monitor the operating parameter, e.g., temperature, power intensity, etc., associated with the apparatus used for setting the ink to ensure proper curing of the printed material. Essential to the curing process is the amount of power supplied to the elements of the setting apparatus or unit. Curing equipment commonly used lacks the precision required to effectively adapt the setting parameters and the device's elements, e.g., quartz bulbs, to the full range of temperatures necessary for proper curing.

Thus, a need exists in the screen printing industry for a control process having the capability to provide precise levels of power to the setting device used during curing of the printed material. In addition, centrally controlling the various sub-processes will significantly improve the quality of the overall printing process.

A need also exists in the screen printing industry to precisely control the temperature within existing curing equipment, while avoiding the power fluctuations of known heating units.

The present invention is provided to solve the problems discussed above and other problems, and to provide advantages and aspects not provided by prior systems of this type. A full discussion of the features and advantages of the present invention is deferred to the following detailed description, which proceeds with reference to the accompanying drawings.

### SUMMARY OF THE INVENTION

The present invention provides a method for operating a drying unit. The method comprises the steps of receiving a temperature setting from a user, and generating a power intensity setting, wherein the power intensity setting is a fraction of the temperature setting. The method further comprises the steps of comparing the power intensity setting to a base power setting, and energizing a heating element based on the comparison of the power intensity setting to the base power setting.

The method can further comprise the step of sensing a temperature within the drying unit. The power intensity setting is based on the temperature sensed within the drying unit. The method can also comprise the steps of initiating a counter, and incrementing the counter by the power intensity setting. Additionally, the method can include the step of decrementing the counter by the base power setting, based on a determination that the counter exceeds a predetermined threshold. The method can further include the step of generating an interrupt signal based on a determination that the counter exceeds the base power setting.

The method can further comprise the step of measuring a parameter of a power source, wherein the step of generating the interrupt signal is based on a determination that the parameter is equal to a predetermined value. The method can also comprise the step of selecting one of a plurality of heaters, and transmitting a signal to the selected one of the plurality of heaters. The method can further include the step of receiving a speed setting from the user, wherein the speed setting determines the fractional value of the power intensity setting relative to the temperature setting.

The present invention further provides a system for operating a drying unit. The system comprises a temperature selector for selecting a temperature setting, and a thermometer for sensing a temperature within the drying unit. The system further comprises a controller for generating a power intensity setting, wherein the power intensity setting is a fraction of the temperature setting. A comparator compares the power intensity setting to a base power setting, and a heating element receives a signal to energize based on the comparison of the power intensity setting to the base power setting.

The power intensity setting of the system can be based on the temperature sensed within the drying unit. The system can also includes a counter, wherein the counter is incremented by the power intensity setting at a predetermined periodic interval. Additionally, the counter can be decremented by the base power setting, if the counter is determined to exceed a predetermined threshold.

The system can also comprise a sensor for measuring a parameter of a power source, wherein the controller generates an interrupt signal based on a determination that the power parameter of the power source is equal to a predetermined value.

The system can further comprise a selector for selecting one of a plurality of heaters. The system can be configured so that a heating signal is transmitted to the selected one of the plurality of heaters.

The system can also include a speed selector for selecting a speed setting, wherein the speed setting determines the fractional value of the power intensity setting relative to the temperature setting.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a flowchart illustrating the processes and steps involved in performing a method in accordance with the principles of the present invention;

FIG. 2 is a diagram illustrating the elements of a system for operating a drying unit configured in accordance with the principles of the present invention; and,

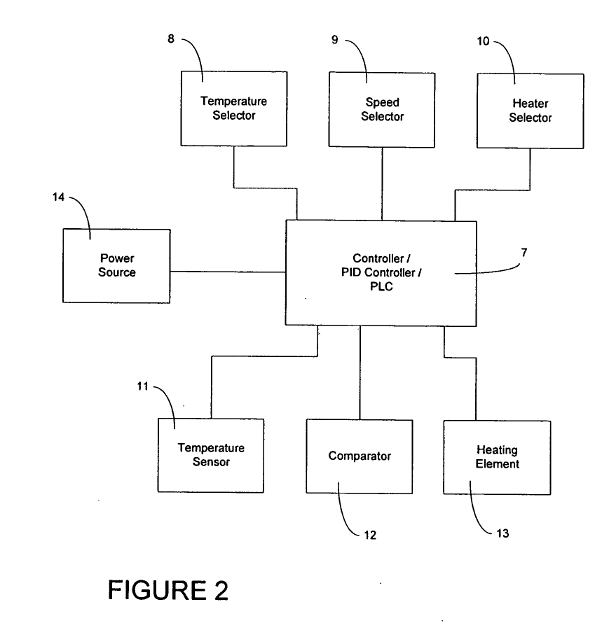

FIG. 3 is a graph illustrating various power intensity output level signals versus time cycles, generated according to the preferred embodiment of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

A method for operating a drying unit is provided. The method first comprises the step of receiving a temperature setting from a user. The temperature setting is preferably an absolute temperature for setting a textile, for example, 90° Fahrenheit. It will be understood that other types of degree systems for measuring temperature, such as Celsius, are practicable in accordance with the principles of the present invention. It will be further understood that a propriety, relativistic temperature measurement system can be employed. For example, a temperature setting of “five” can correspond relatively to a temperature of 90° Fahrenheit, while a temperature setting of “four” can correspond relatively to a temperature of 80° Fahrenheit, and so on.

The method further comprises the step of generating a power intensity setting, wherein the power intensity setting is a fraction of the temperature setting. In other words, the power intensity setting is some portion of—and is proportional to—the temperature setting. The power intensity setting serves as a means to maintain a temperature within the drying unit that is proportional to the user-selected temperature setting. For example, if the temperature setting is 90° F., the power intensity setting will be set to a value needed to produce a temperature of 90° F. within the drying unit, e.g., 200 volts. In a preferred embodiment, the power intensity setting is proportional to the temperature setting. In light of U.S. patent application Ser. No. 10/603,018, assigned to the assignee of the present invention, it will be understood that the power intensity setting is kept proportional to the temperature setting, such that the power intensity within the drying unit is maintained at a level proportion to the user-provided temperature setting and a base power setting, also referred to as a base resolution.

The method further comprises the step of comparing the power intensity setting to the base power setting. Then, based on that comparison, a heating element is energized. In a preferred embodiment, the heating element is energized if the power intensity setting is greater than the base power setting. It will be understood, however, that similar results could be achieved based on the same comparison executed in reverse order. In other words, the heating element can be energized if the power intensity setting is less than the base power setting. In either embodiment, the power intensity setting remains a fraction of—and proportional to—the user-provided temperature setting.

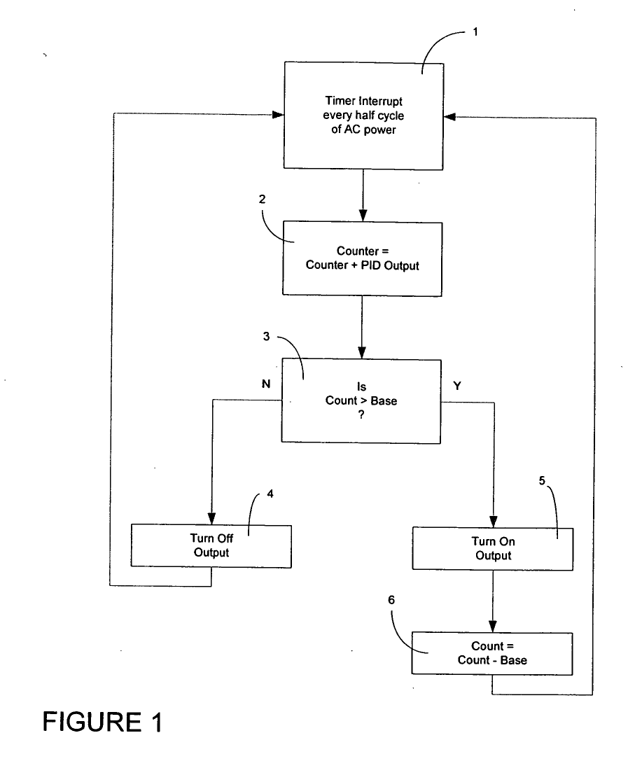

Referring initially to FIG. 1, a preferred embodiment of the method for operating a drying unit is illustrated. In step 1, incoming power current is measured in cycles. Preferably, the input power current is an alternating current (“AC”), but it will be understood the invention is practicable with a direct current (“DC”) as well. It will be further understood a power current fluctuates on a sinusoidal wave, between an upper bound and a lower bound of electrical charge. For example, an electrical current of 120 volts actually fluctuates, on a sinusoidal wave, between a range of current surrounding 120 volts; e.g., between 121 and 119 volts. A sinusoidal wave has a cycle which fluctuates at a known and predictable variance over a known and predictable period of time. In a preferred embodiment, in step 1, a timer interrupt is executed at every half cycle of the electrical current. By executing the timer interrupt at every half cycle, the current system and method is thereby able to perform the energizing of the heating element in a way that is less stressful on the components of the system, in particular the power source. Thus, the present method provides for measuring a parameter of the power source, such as the electrical current, and generates the interrupt signal based on a determination that the electrical current is equal to a predetermined threshold, such as the half cycle of the sinusoidal wave of the electrical current, as the sinusoidal wave crosses the horizontal current axis.

The method further comprises the step of sensing a temperature within the drying unit, via a temperature sensor 11. The temperature within the drying unit is inputted into a proportional-derivative-integral (“PID”) controller 7. The PID controller 7 measures the electrical current provided by power source 14 and the temperature measured by the temperature sensor 11, and provides a power intensity setting based on the temperature setting. In a preferred embodiment, as illustrated in step 2, the power intensity setting is then added to a counter. In computer programming parlance, the counter is thereby incremented by the power intensity setting. It will be understood that a counter is an iterative variable used in computer programming to determine a number of cycles for a particular segment of a program to be performed, and that preferably, a counter is initialized before the segment is performed.

In step 3, it is determined whether the counter exceeds a predetermined threshold, e.g., a base power setting or base resolution. If it is determined that the counter does not exceed the predetermined threshold, the heating element is not energized, and the method returns to step 1, as illustrated in FIG. 1. (Variably, as illustrated in step 4, if the heating element 13 is energized when the determination is made that the counter does not exceed the base power setting, the heating element 13 is de-energized, turned off, before the method repeats in step 1.) If, in step 3, it is determined that the counter exceeds the predetermined threshold, the heating element 13 is energized, in step 5. Then, in step 6, the counter is decremented by the base power setting before the method repeats itself in step 1. Thus, by using the counter, the present method provides that the power intensity setting will be proportional to the user-provided temperature setting.

In a preferred embodiment, the present invention provides a heater selector 10 for selecting from among a plurality of heating elements 13. The heater selector 10 can be a manual selector provided to the user, such as a knob or push-button selector, or can be an automatic selector. When a plurality of heating elements 13 are present, the user can use the heating selector 10 to select which of the heating elements 13 will be energized; alternatively, the selector 10 can be automatic. In another embodiment, logic comprising the heating selector 10 determines a random heating element 13 to energize within the drying unit. Alternatively, the heating selector 10 logic may be embedded within the controller 7.

In one embodiment, the comparison between the counter and the base power setting is made by the controller 7. Alternatively, as illustrated, a comparator 12 may be used to make the comparison. It will be understood that a comparator is a type of circuitry used to compare two values.

In another embodiment, the present invention provides a speed selector 9 for selecting from among a plurality of speeds. The speed setting determines the fractional value of the power intensity setting relative to the temperature setting. In other words, the speed setting determines the value at which the power intensity setting will be held proportional to the temperature setting. A higher speed setting will thus have the effect of increasing the power intensity setting, whereas a lower speed setting will have the effect of decreasing the power intensity setting.

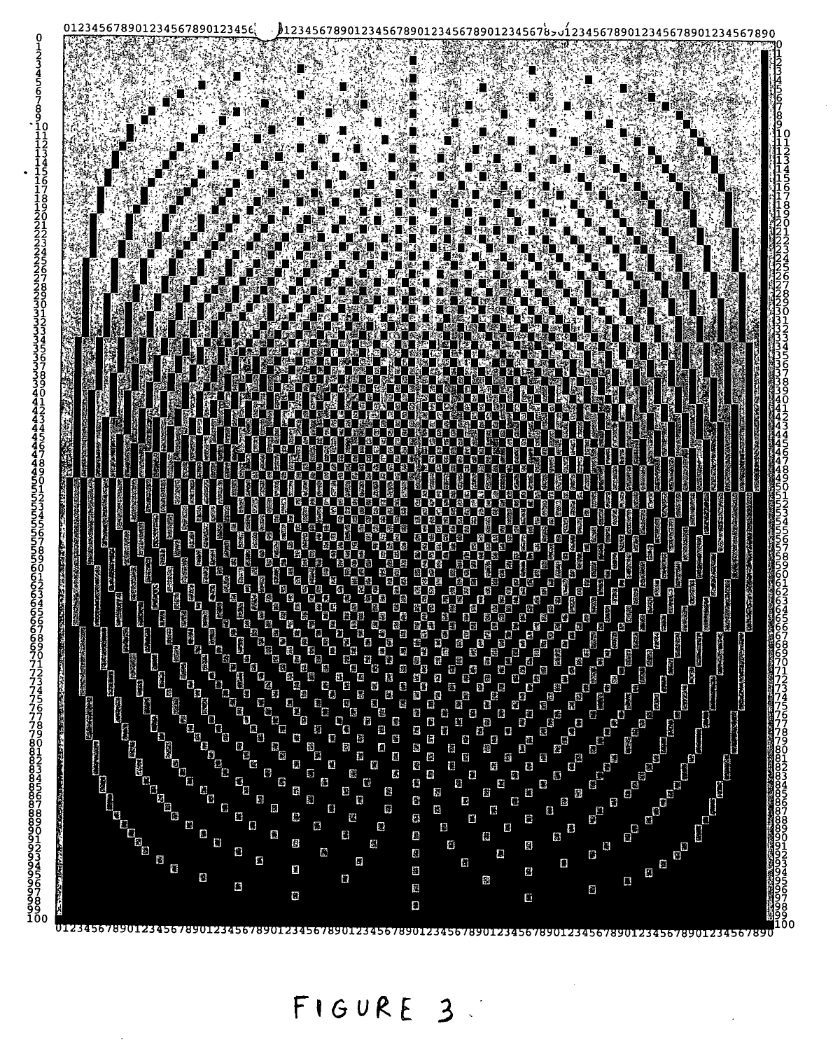

Referring now to FIG. 3, a graph is provided illustrating various power intensity settings versus time cycles for the present invention. FIG. 3 illustrates the resulting power intensity setting over 100 calculation intervals. Each row represents a power intensity signal generated in response to the power intensity setting/temperature setting and base resolution. Each column represents a range of 100 calculation intervals, wherein the shaded segments represent the “energized” state and the non-shaded segments represent a non-energized state. The result of applying the method provided by the present invention is a power intensity output from 0 to 100%. As is shown in FIG. 3, each power intensity setting can generate 100 patterns, each pattern corresponding to a counter value in the cycle. Thus, each column in FIG. 3 represents the 100 cycles before the pattern repeats itself.

While the specific embodiments have been illustrated and described, numerous modifications come to mind without significantly departing from the spirit of the invention, and the scope of protection is only limited by the scope of the accompanying Claims.

What is claimed is:

1. A method for operating a drying unit, comprising the steps of:
receiving a temperature setting from a user;
generating a power intensity setting, wherein the power intensity setting is a fraction of the temperature setting;
comparing the power intensity setting to a base power setting; and,
energizing a heating element based on the comparison of the power intensity setting to the base power setting.

2. The method of claim 1, further comprising the step of:
sensing a temperature within the drying unit.

3. The method of claim 2, wherein the power intensity setting is based on the temperature sensed within the drying unit.

4. The method of claim 1, further comprising the steps of:
initiating a counter; and,
incrementing the counter by the power intensity setting.

5. The method of claim 4, further comprising the step of:
decrementing the counter by the base power setting based on a determination that the counter exceeds a predetermined threshold.

6. The method of claim 1, further comprising the step of:
generating an interrupt signal based on a determination that the counter exceeds the base power setting.

7. The method of claim 6, further comprising the step of:
measuring a parameter of a power source, wherein the step of generating the interrupt signal is based on a determination that the parameter is equal to a predetermined value.

8. The method of claim 1, further comprising the step of:
selecting one of a plurality of heaters.

9. The method of claim 8, further comprising the step of:
transmitting a signal to the one of the plurality of heaters.

10. The method of claim 1, further comprising the step of:
receiving a speed setting from the user, wherein the speed setting determines the fractional value of the power intensity setting relative to the temperature setting.

11. A system for operating a drying unit, comprising:
a temperature selector for selecting a temperature setting;
a thermometer for sensing a temperature within the drying unit;
a controller for generating a power intensity setting, wherein the power intensity setting is a fraction of the temperature setting;
a comparator for comparing the power intensity setting to a base power setting; and,
a heating element for receiving a signal to energize based on the comparison of the power intensity setting to the base power setting.

12. The system of claim 11, wherein the power intensity setting is based on the temperature sensed within the drying unit.

13. The system of claim 11, further comprising:
a counter, wherein the counter is incremented by the power intensity setting at a predetermined periodic interval.

14. The system of claim 13, wherein the counter is decremented by the base power setting based on a determination that the counter exceeds a predetermined threshold.

15. The system of claim 11, wherein the controller generates an interrupt signal based on a determination that the power intensity setting exceeds the base power setting.

16. The system of claim 15, further comprising:
a sensor for measuring a parameter of a power source, wherein the interrupt signal is generated based on a determination that the parameter is equal to a predetermined value.

17. The system of claim 11, further comprising:
a selector for selecting one of a plurality of heaters.

18. The system of claim 17, wherein a heating signal is transmitted to a selected one of the plurality of heaters.

19. The system of claim 11, further comprising:
a speed selector for selecting a speed setting, wherein the speed setting determines the fractional value of the power intensity setting relative to the temperature setting.

20. A control system for a textile heating unit, comprising:
a user interface for receiving a temperature setting and a speed setting from a user;
a power supply for generating an electrical current; and,
a programmable logic circuit comprising electrical logic for:
initiating a counter;
incrementing the counter by a power intensity setting, wherein the power intensity setting is a fraction of the temperature setting;
comparing the counter to a base power setting;
generating an energize signal and decrementing the counter by the base power setting if the counter is greater than the base power setting; and,
generating an interrupt signal, wherein the interrupt signal is generated when the electrical current is at a predetermined sinusoidal threshold.
